(19) United States
(12) Patent Application Publication
(10) Pub. No.: US 2013/0024856 A1
(43) Pub. Date: Jan. 24, 2013

(54) METHOD AND APPARATUS FOR FLEXIBLE BOOTING VIRTUAL STORAGE APPLIANCES

(71) Applicant: Dmitry YUSUPOV, Cupertino, CA (US)

(72) Inventor: Dmitry YUSUPOV, Cupertino, CA (US)

(73) Assignee: Nexenta Systems, Inc., Mountain View, CA (US)

(21) Appl. No.: 13/186,179

(22) Filed: Jul. 19, 2011

(51) Int. Cl. G06F 9/455

(52) U.S. Cl. 718/1

(57) ABSTRACT

Virtual storage methods and systems allow storage software to be used with a variety of systems and resources without the need to write storage software specific to each particular system. The methods and systems described herein render virtual storage flexibly adaptable to hardware platforms. Through use of a dynamic resource mapper and a start-up loader in booting storage systems, the use of virtual storage appliances is simplified in an integrated and transparent fashion. For ease of system configurations, the mapper and start-up loader are available in a different ways and from a variety of media.

### TECHNICAL FIELD

Discussed herein are systems and methods that render storage software flexibly adaptable to different hardware platforms.

### BACKGROUND

Computer systems require storage for their data. Storage software running on particular hardware assists a computer system in efficiently and safely storing data by taking advantage of the system's storage resources. For example, the storage software can use a computer's hard disk, RAM, and external memory to store information. Moreover, the storage software can be used with a system of networked computers, where the storage software would use the resources of the entire system to store system information. To operate with a particular system, the storage software is written to be compatible with that system's hardware.

### SUMMARY

With the systems and methods described herein, storage software can be used with a variety of systems without the need to write storage software specific to each particular system. The methods and system described herein render storage software flexibly adaptable to hardware platforms. Furthermore, through integration and transparency (software and hardware), the method and system simplify use of virtual storage appliances or VSAs, as discussed below in the preferred embodiments.

A system is described for booting one or more virtual storage appliances operable with a computer system having a boot loader, memory, and other available resources. The system includes a kernel, a hypervisor for one or more virtual machines, and a mapper for mapping resources to one or more virtual machines. The system further includes a loader for starting during a boot-up the one or more virtual machines with the resources as mapped by the mapper, each virtual machine to be provisioned with a storage software. Additionally, the system includes a kernel configuration file with directions to the kernel for executing the loader and mapper, wherein the kernel, the hypervisor, the mapper, and the loader and the kernel configuration file are adapted to be loaded by the boot loader into the memory.

Described herein is also a method for mapping resources for one or more virtual storage appliances. The method includes identifying system resources available to one or more virtual machines. And, if resources are available, the method further includes dynamically constructing meta data for one or more virtual machines to be provisioned with storage software.

### BRIEF DESCRIPTION OF THE DRAWINGS

FIG. 1 illustrates an image of software modules in a preferred embodiment.

FIG. 2 illustrates system resources in a preferred embodiment.

FIG. 3 illustrates the steps in booting the system in a preferred embodiment.

FIG. 4 illustrates virtual machine meta data in a preferred embodiment.

FIG. 5 illustrates a hot-plug event in a preferred embodiment.

FIG. 6 illustrates a console in a preferred embodiment.

Like reference numbers and designations in the various drawings indicate like elements.

### DETAILED DESCRIPTION

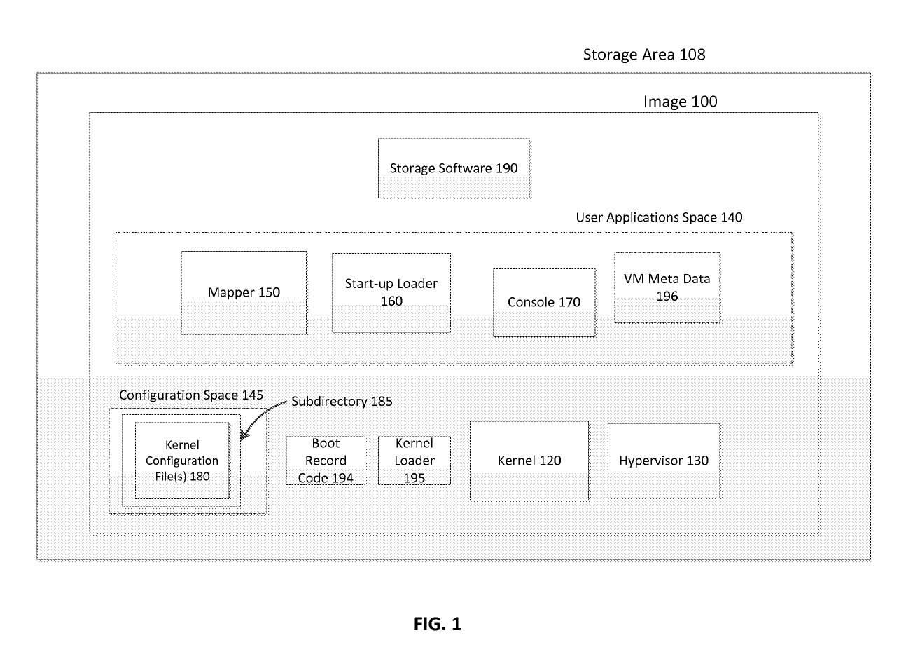

In a preferred embodiment, as illustrated in FIG. 1, a storage area 108 stores an image 100 of a number of software modules or software components including a kernel 120, a hypervisor 130, user applications, such as a mapper 150, a start-up loader 160 (e.g., start-up script), a console 170, and possibly storage software, such as NexentaStor™ 190. As one of ordinary skill in the art would recognize based on the description herein, the software modules might themselves include other software modules or components. Although not shown, the image 100 also includes other parts for a typical operating system.

The user applications may be stored, for instance, in user space 140 of the storage area 108. A configuration space 145 holds one or more kernel configuration files 180 contained within one or more kernel subdirectories 185. And one or more of these subdirectories 185 contains persistently stored custom rules for device management.

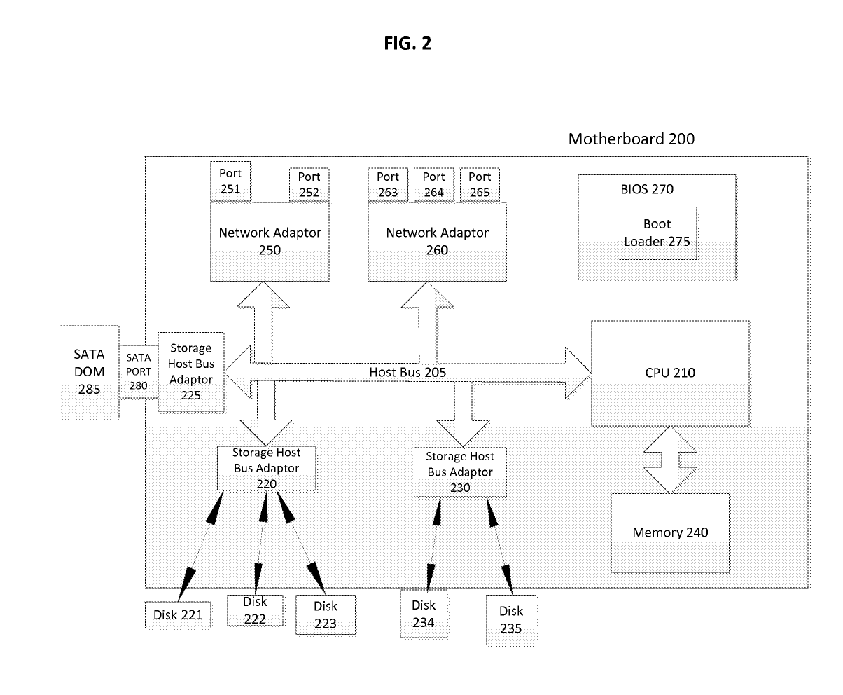

In addition, the image 100 preferably includes a master boot record code 194 with an instruction pointer to a kernel loader 195, which is also part of the image. Virtual machine meta data 196 may be stored as well, as further discussed below. As also described further below, the start-up loader 160 is a module in addition to a boot loader 175 (see FIG. 2).

The term image refers to compressed software module(s). The storage area 108 may be a storage device, such as external memory, for example, a network accessed device. Alternatively, it could be a hard disk or CD ROM. Indeed, the storage area may be flash memory inside a system, for example on a motherboard. Preferably the storage area is a mass storage device that is highly reliable in persistently storing information. For example, it may be external flash memory, such as a SATA DOM flash drive. SATA refers to Serial Advanced Technology Attachment and DOM refers to disk on module.

The kernel 120 is a core part of a computer's operating system, which is not limited to a particular kind of operating system. It could be any number of operating systems, such as Microsoft™ or Linux™. The particular operating system typically will have an associated hardware compatibility list (HCL), which lists computer hardware compatible with the operating system. Adapting this to advantage, through the integration of the start-up loader 160 and mapper 150 with the hypervisor 130, the storage software need not be written for hardware particulars.

Preferably the kernel configuration file(s) 180 contain custom information for use by the kernel 120, such as immediate steps that the kernel 120 is to execute upon boot up. Additionally, in the preferred embodiment, the kernel's subdirectory 185 contains custom rules that are persistently stored and that the kernel 120 follows in operation. Under these rules pertaining to device management, the kernel updates the subdirectory 185 with information about hot plug events, discussed further below.

Based on the virtual machine meta data 196, the hypervisor 130, also known as a virtual machine monitor, allocates and manages physical resources for one or more virtual machines. A virtual machine emulates hardware architecture in software. The virtual machine allows the sharing of the underlying physical machine resources between different virtual machines, each running its own operating system.

The image 100 of the software modules can be used with a variety of computer systems and networks, including with a motherboard of a server. As illustrated in FIG. 2, the motherboard 200 with a BIOS chip 270 with a stored boot loader 275, may have available to it—off board 200 or on board 200—a number of resources interconnected by a host bus 205, storage host bus adaptors 220, 225, 230, and network adaptors 250, 260. The resources include one or more CPUs (central processing unit) 210; one or more disks 221, 222, 223, 234, 235 coupled to their corresponding storage host bus adaptors 220, 230; memory 240; one or more network adaptor ports 251, 252, 263, 264, 265 of the network adaptors 250, 260; and a bus interface 280 coupled to mass storage devices. The ports 251, 252, 263, 264, 265 could be a variety of ports including Ethernet ports. The bus interface 280 may be a SATA port. The disks 221, 222, 223, 234, 235 may be either locally or remotely connected storage, such as physical (e.g., hard disk, flash disk, etc.) or virtualized storage.

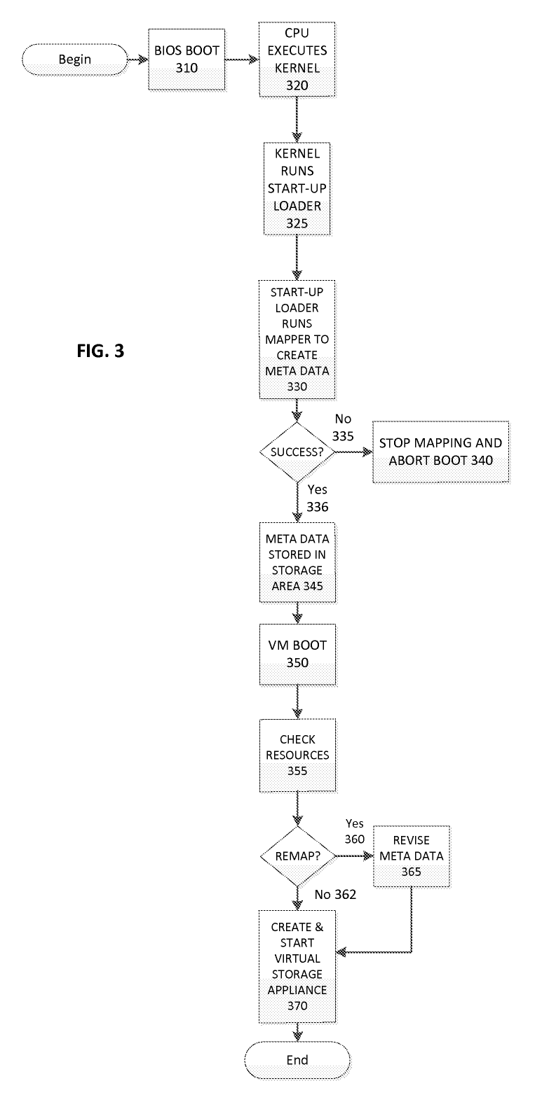

FIG. 3 illustrates the overall operation of the preferred embodiment. Initially, the storage area 108, such as external memory 285 holding the image 100 is connected to the bus interface 280 of a computer system 200. After the system's power is turned on, during BIOS booting 310, the boot loader 275 on the BIOS chip 270 prompts, for example, a user to select the external memory 285 as the source for the operating system to be loaded into memory 140. The boot loader 275 reads the image 100 and stores it in the motherboard's memory 240. The boot loader 275 also loads the master boot record code 194. And the CPU 210 executes this code 194 to load the kernel loader 195.

To begin executing 320 the kernel, the CPU 210 first executes the kernel loader 195 to load the kernel 120. The kernel 120 identifies and classifies resources in the computer system 200. In addition, preferably the kernel 120 refers to its configuration file(s) 180 to begin executing user applications in space 140.

As provided by the configuration file (s) 180, preferably, the kernel 120 executes 325 the start-up loader 160. The start-up loader 160 then executes 330 the mapper 150, which reads the kernel's 120 identification and classification of resources and in turn identifies resources for one or more virtual storage appliances. A virtual storage appliance is storage software 190 running on a virtual machine and provides a pool of shared storage for users. Each virtual machine is provisioned with its storage software 190, for example, by having the storage software 190 NexentaStor™ installed on each virtual machine.

Next, transparently to a user, the mapper constructs 330 virtual machine meta data 196 and stores it in the flash memory 285. To flexibly adapt to different systems with different resources, preferably the mapper 150 constructs the meta data 196 dynamically rather than in advance.

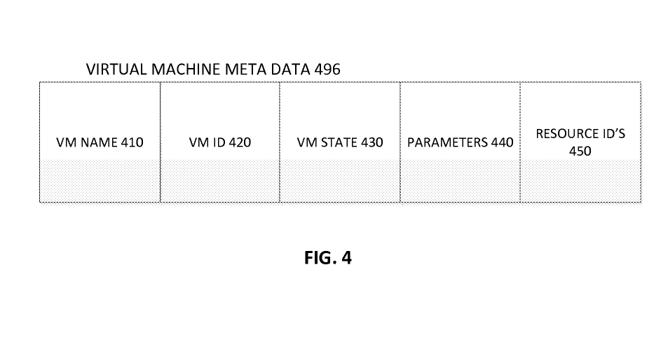

The meta data 196 could be, for example, plain text file, database, or structured mark-up, e.g., XML (Extensible Mark-up Language). The information included in the meta data 196 is illustrated in FIG. 4. Meta data 496 may include the names 410, changeable by a user, of one or more virtual machines (VM), their identification numbers 420, the state(s) of virtual machine 430, parameters 440, and an identification of resources 450, such as network ports 251, 252, 263, 264 and 265 and disks or disk drives 221, 222, 223, 234, 235 assigned, i.e., mapped to the virtual machine(s). The state of the virtual machine 430 indicates whether, for example, the virtual machine is installed, stopped, or running. Initially, when the virtual machine has never been started, the state 430 would indicate that it has yet to be installed. The parameters 440, in turn, specify, for example, use of the CPU's 210 time in percent as allocated among different virtual machines. To illustrate, one virtual machine may use fifty percent of the CPU 210, while another virtual machine may use twenty percent of the same CPU 210.

Returning to FIG. 3, construction of the virtual machine meta data 196 may fail 335 if resources that the storage software 190 wants or needs to operate are missing, such as, for example, the CPU(s) 210, RAM 240, hard disk 221, or networking port 251. In case of failure 335 of mapping a first virtual machine, the mapper 150 stops mapping 340 and issues an error message that may appear on the console asking the user to power cycle the system. Additionally, the start-up loader 160 stops 340 operation of the boot process by entering a halt state through, for example, an infinite loop.

But there may be success 336, even if only partial. For instance, if mapping for the first virtual machine succeeded 336 but failed for a second virtual machine (for example, an operator may elect to have more than one virtual machines), the mapper 150 sends a message to a log file of the kernel 120 for remedial action, for example, by the system's administrator. But the first virtual machine is nevertheless readied for operation.

Partial success 336 may also be achieved, if for example, only some of the resources are missing, such as one of multiple CPUs 210. Then the mapper 150 may construct a degraded virtual machine meta data 196. The map may include marking of the degraded resource for future reference. Such marking would be included in the meta data 496 as additional information.

For the default case, assuming no failure 336, the mapper constructs the meta data 196 with, for example, one-to-one mapping, wherein the resources—depending on their availability—are mapped to the single virtual machine. But not necessarily all of a particular resource is mapped to a virtual machine. The hypervisor 130 may require part of one or more resources, e.g., memory 240 or disk 222, or CPU 210.

The mapper 150 allows a user to change the default mapping to a custom mapping. Alternatively, certain custom mapping may be pre-programmed. In that case, the custom mapping happens dynamically. Moreover, to simplify customization and render it repeatable, custom mapping may be based on a template. Knowing in advance the resources available to virtual storage appliances, allows for pre-mapping of the resources to virtual machines.

In custom mapping, resources may be assigned among multiple virtual machines. While one of ordinary skill in the art will recognize based on the description herein that different assignments are possible, the following are illustrative. For instance, there may be a split in the assignment, where one virtual machine is assigned part of the resources and another is assigned another part of the resources, although some resources, e.g., a CPU 210, may be shared among the virtual machines. See Table 1 below, the information for which can be included with the meta data as resource identification 450.

TABLE 1

| Virtual Machine ID (identification) | Resource |
|---|---|
| 1 | Network Adaptor Port 251 |
| 1 | Disk 221 |
| 1 | Disk 222 |
| 1 | CPU 210 |
| 2 | Network Adaptor Port 263 |
| 2 | Disk 234 |
| 2 | Disk 235 |
| 2 | CPU 210 |

Alternatively, the same resources may be assigned to each virtual machine, as shown below in Table 2.

TABLE 2

| Virtual Machine ID (identification) | Resource |
|---|---|
| 1, 2 | Network Adaptor Port 251 |
| 1, 2 | Network Adaptor Port 263 |
| 1, 2 | CPU 210 |
| 1, 2 | Disk 221 |
| 1, 2 | Disk 222 |
| 1, 2 | Disk 223 |
| 1, 2 | Disk 234 |

The mapper 150 also stores 345 these custom assignments in the storage area 108. Although custom mapping was discussed for multiple virtual machines, the mapper 150 may also provide custom mapping for a single virtual machine. Either kind of map—default or custom—is stored preferably persistently in memory space that will not be overwritten, such as within the configuration space 145.

The storage software 190, for example, may have been previously stored in the external memory 285 or on hard disk of a system 200, or alternatively could be downloaded over the internet, for example, through the console 600 discussed below. Indeed, the default single virtual machine may be pre-provisioned (pre-installed in storage area 108, pre-configured, and ready to use) with its storage software 190. For instance, if the resources are known in advance, as well as the desired mapping, then the virtual machine meta data 196 can be constructed in advance and stored in the storage area 108, for example, by a system operator through the console 600. Depending on preference, only one copy of the storage software 190 may need to be stored, as multiple copies may be generated from the first copy through, for instance, a copy-on-write strategy to create additional versions of the storage software 190, as needed.

After mapping is complete, the system initiates a virtual machine boot 350. The start-up loader 160 may prompt the user to identify the media from which to boot up. For example, the media could be external media 285, system hard disk, CD-ROM, or storage elsewhere, such as in a cloud.

The start-up loader 160 runs the mapper 150 to confirm 355 the status of the resources. To the extent adjustments are made 360 because resources have degraded, are missing or have been added, the mapper 150 re-maps 365 the resources to the virtual machine(s).

Whether remapping happens 360 or not 362, the start-up loader 160 reads the virtual machine meta data 196 stored in the storage area 108 and calls the hypervisor 130 to construct 370 a virtual machine from each corresponding virtual machine meta data 196. The hypervisor 130 issues a command to run 370 the storage software 190 on corresponding virtual machines that have resources mapped to them. The hypervisor 130 is then ready to manage, control, and/or serve the virtual machine(s), including instructing each virtual machine to run its storage software 190.

In addition to its other functions, the start-up loader 160 has access to the meta data 196 and thereby also tracks the state of a virtual machine 430. For instance, a virtual machine may be stopped, for example, by a system operator. In that case, the start-up loader 160 maintains the virtual machine in its stopped state 430. The start-up loader 160 will maintain the virtual machine in the stopped state 430, including upon shut down with a subsequent power-up. Nevertheless, the start-up loader 160 can instruct the hypervisor 130 to start other virtual machines.

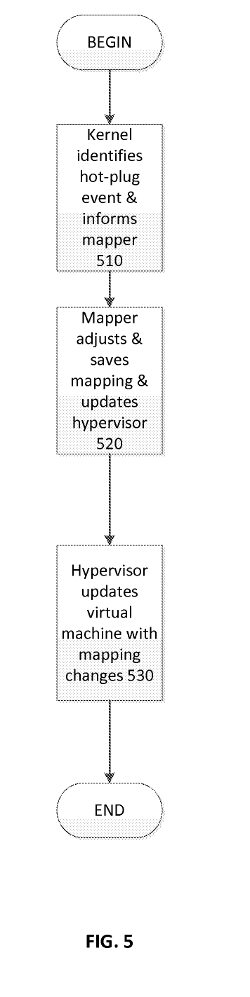

The mapper's 150 on the fly construction of virtual machine meta data 196 makes it possible to adjust to changes in available resources, such as in a hot plug event, when for instance disks 221, 222, 223, 234, 235 are added, degraded, and/or removed. As illustrated in FIG. 5, through application of the custom rules in the subdirectory 185, the kernel 120 identifies 510 hot plug events and informs 510 the mapper 150 of the event. The information provided 510 includes, for example, the disk's GUID (Global Unique Identification) and the corresponding identities of the disk slots, i.e., the disk's 221, 222, 223, 234, 235 locations in the system.

Upon a hot-plug event, the mapper 150 preferably translates 520 the hot-plug information into a mapping change for the virtual storage appliances. One of ordinary skill in the art will recognize based on this disclosure that a variety of mapping adjustments can be made. For instance, to simplify mapping, the mapper 150 may add additional resources to only one of the virtual machines, for example, always to the same virtual machine, e.g., to the first virtual machine or to a designated master virtual machine. Alternatively, the mapper 150 may map additional resources equally to multiple virtual machines. The mapper 150 then informs 520 the hypervisor 130 of the changes, and the hypervisor 130 informs the virtual machine of the mapping changes.

If, however, a resource, e.g., disk 221, is removed from a second virtual storage appliance and then another disk, e.g., disk 222, is added into the same slot, the mapper preferably treats the addition as a replacement, i.e., updates the GUID but maintains the slot number. Other mapping strategies may be employed as well, depending on the particulars of a system and/or desired usage.

The mapper 150 saves 520 updated virtual machine meta data 196 in the storage area 108 and informs 520 the hypervisor 130, which in turn updates 530 the virtual machine with the updated mapping. Thereafter, the hot-plug process can repeats itself, as appropriate.

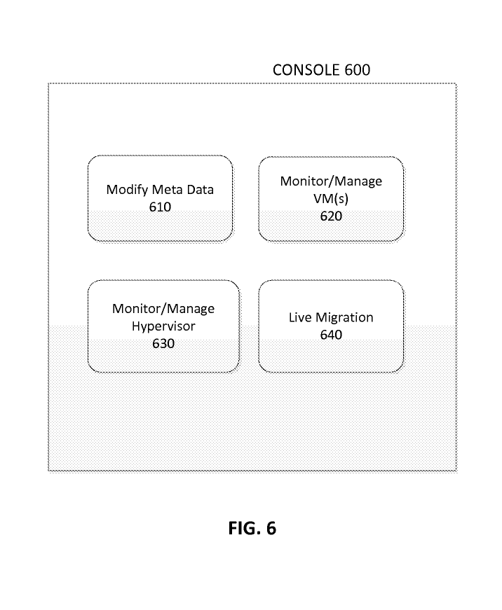

Optionally, for ease of manual control of the hypervisor 130, a user interface or console 600 may be added as a management tool for a system operator, as illustrated in FIG. 6. Through this console 600, the operator may provide management commands to the hypervisor 130. These commands preferably include commands for the following: modifying the virtual machine meta data 196 and templates 610; monitoring virtual machine (s) (including identifying resources in use and the status of the resources) 620; virtual machine management (including starting and stopping virtual machine(s)) 620; monitoring the hypervisor 130 (including various system functions, e.g., status of system power, system fan for cooling and the hypervisor's 130 usage of the CPU and memory) 630; connecting the hypervisor 130 to a network of one or more other hypervisors in multi-system applications 630; and perform live migration (to achieve more balanced usage of resources by reassigning resources among virtual storage appliances) 640.

The detailed description above should not serve to limit the scope of the inventions. Instead, the claims below should be construed in view of the full breadth and spirit of the embodiments of the present inventions, as disclosed herein.

We claim:

1. A system for booting one or more virtual storage appliances operable with a computer system having a boot loader, memory, and other available resources, the system comprising:
a kernel;
a hypervisor for one or more virtual machines;
a mapper to map resources to one or more virtual machines;
a loader to direct the hypervisor to construct and run the one or more virtual machines with the resources as mapped by the mapper, each virtual machine to be provisioned with a storage software; and
a kernel configuration file with directions to the kernel to execute the loader and mapper, wherein the kernel, the hypervisor, the mapper, and the loader and the kernel configuration file are adapted to be loaded by the boot loader into the memory.

2. The system of claim 1, wherein the kernel, hypervisor, mapper, and loader and the kernel configuration file comprise an image in a storage area.

3. The system of claim 2, wherein the image includes an image of the storage software.

4. The system of claim 2, wherein the storage area is a storage device that persistently stores the image.

5. The system of claim 4, wherein the storage device is flash memory.

6. The system of claim 1, wherein the computer system is a server.

7. The system of claim 1, the one or more virtual storage appliances comprising one or more virtual machines running storage software.

8. The system of claim 1, the mapper capable of adjusting the mapping while the one or more virtual storage appliances are operating.

9. A method for booting one or more virtual storage appliances in a system, the method comprising:
booting the system;
mapping resources available to one or more virtual machines;
storing one or more resource maps in a storage area;
provisioning one or more virtual machines with one or more storage software to create one or more virtual storage appliances; and
starting the one or more virtual storage appliances in the system.

10. The method of claim 9, further comprising the steps of
verifying the presence of resources; and
depending on a change in available resources, remapping one or more resources to the one or more virtual machines.

11. The method of claim 10, comprising the step of booting the virtual machine.

12. The method of claim 9, wherein the step of starting comprises activating a hypervisor to start the one or more virtual machines to run their corresponding storage software.

13. The method of claim 9, wherein the storage area is a memory device, the step of storing further comprising persistently storing the one or more resource maps in the storage device.

14. The method of claim 13, wherein the storage memory is a flash memory.

15. The method of claim 9, further comprising:
detecting a hot-plug event; and
in response to the hot-plug event, adjusting the mapping of one or more resources available to one or more virtual machines.

16. The method of claim 9, further comprising aborting booting a first time for lack of resources.

17. A computer program product, comprising a computer usable medium having a computer readable program code embodied therein, said computer readable program code adapted to be executed to implement a method for booting one or more virtual storage appliances, said method comprising:
booting to start operation of a kernel;
mapping resources available to one or more virtual machines;
storing one or more resource maps in a storage area;
provisioning one or more virtual machines with one or more storage software to create one or more virtual storage appliances; and
starting the one or more virtual storage appliances.

18. The computer program product of claim 17, said method further comprising:
verifying the presence of resources; and
depending on a change in available resources, remapping one or more resources to the one or more virtual machines.

19. A computer program product, comprising a computer usable medium having a computer readable program code embodied therein, said computer readable program code adapted to be executed to implement a method for booting one or more virtual storage appliances, said method comprising:
loading with a boot loader a master boot record;
loading with the master boot record a kernel loader;
loading with the kernel loader a kernel;
executing with the kernel a start-up loader;
executing with the start-up loader a mapper;
mapping with the mapper one or more resources to one or more virtual machines;
starting with the start-up loader the one or more virtual machines with the one or more resources as mapped by the mapper, each virtual machine to be provisioned with storage software; and
managing with a hypervisor the one or more virtual machines.

20. A computer system for booting one or more virtual machines comprising:
one or more resources;
a mapper for mapping one or more resources to one or more virtual machines;
storage software;
a start-up loader for starting during a boot-up the one or more virtual machines with the one or more resources as mapped by the mapper, each virtual machine to be provisioned with the storage software;
a kernel;
one or more kernel configuration files for having the kernel execute the start-up loader and the mapper;
a kernel loader to load the kernel;
a master boot record to load the kernel loader;
a boot loader to load the master boot record;
a memory; and
a hypervisor for one or more virtual machines;
wherein the kernel, the hypervisor, the mapper, the start-up loader, and the one or more kernel configuration files are adapted to be loaded by the boot loader into the memory.
